(19) United States
(12) Patent Application Publication
(10) Pub. No.: US 2018/0030187 A1
(43) Pub. Date: Feb. 1, 2018

(54) POLYMER, ION EXCHANGE MEMBRANE AND STRUCTURAL ENHANCED MEMBRANE EMPLOYING THE SAME

(71) Applicant: INDUSTRIAL TECHNOLOGY RESEARCH INSTITUTE, Hsinchu (TW)

(72) Inventors: Chiu-Tung WANG, Changhua County (TW); Li-Duan TSAI, Hsinchu City (TW); Cheng-Hsiu TSAI, Hsinchu City (TW); Hsuan-Wei LEE, Pingtung County (TW); Chiu-Hun SU, Hsinchu City (TW); Ming-Chou CHEN, Hsinchu County (TW)

(73) Assignee: INDUSTRIAL TECHNOLOGY RESEARCH INSTITUTE, Hsinchu (TW)

(21) Appl. No.: 15/587,045

(22) Filed: May 4, 2017

(30) Foreign Application Priority Data
Jul. 28, 2016 (TW) 105123851

(51) Int. Cl. C08F 226/06; C08J 3/24; C02F 1/461; H01M 8/0239; H01M 2/16; C25B 13/08; C08J 5/22; C08F 212/14

(52) U.S. Cl. CPC C08F 226/06; C08J 5/2231; C08J 3/24; C08F 212/14; H01M 8/0239; H01M 2/1653; C25B 13/08; C02F 1/46104; C08J 2339/04; C08J 2325/18

(57) ABSTRACT

A polymer, ion exchange membrane, and structural enhanced membrane employing the same are provided. The polymer includes a first repeating unit and a second repeating unit. In particular, the first repeating unit is

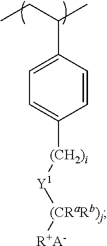

and, the second repeating unit is

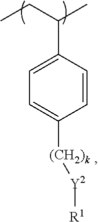

wherein R⁺ can be

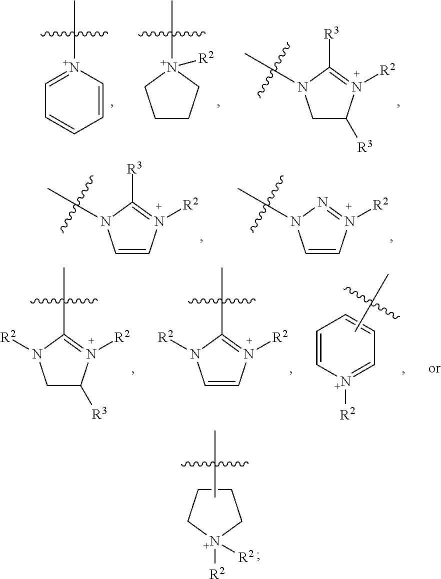

A⁻ can be F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; Y¹ and Y² can be independently —O—, —S—, —CH₂—, or —NH—; R^{a} and R^{b} can be independently hydrogen or C₁₋₈ alkyl group; i, j, and k can be independently 0 or an integer from 1 to 6; R¹ can be C₁₋₁₀ alkyl group or C₅₋₆ cycloalkyl group; and, R² and R³ can be independently hydrogen, C₁₋₈ alkyl group, vinyl group, C₆₋₁₂ aryl group, or allyl group.

### CROSS REFERENCE TO RELATED APPLICATIONS

The application is based on, and claims priority from, Taiwan Application Serial Number 105123851, filed on Jul. 28, 2016, the disclosure of which is hereby incorporated by reference herein in its entirety.

### TECHNICAL FIELD

The technical field relates to a polymer, an ion exchange membrane, and a structural enhanced membrane.

### BACKGROUND

Ion exchange membranes are widely used in electrodialysis purification, fuel cells, electroplating, and the food industry.

An ion exchange membrane includes a polymer material having negatively charged groups or positively charged groups serving as the film body, and migratable cations or anions under electrical or chemical potential. A cation exchange membrane has negatively charged groups fixed on the polymer and migratable cations. Similarly, an anion exchange membrane has positively charged groups fixed on the polymer and migratable anions. In general, the characteristics of the ion exchange membrane are determined by the number, type, and distribution of the fixed charged group. Anion exchange membranes made of a conventional polymer material are not suitable for use in an ion exchange membrane fuel cell, due to the poor solubility, mechanical strength, and solvent selectivity of conventional polymer materials.

### SUMMARY

According to an embodiment of the disclosure, the disclosure provides a polymer including a first repeating unit and a second repeating unit, wherein the first repeating unit can be

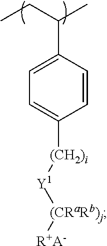

the second repeating unit can be

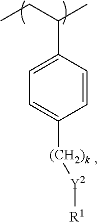

wherein R⁺ can be

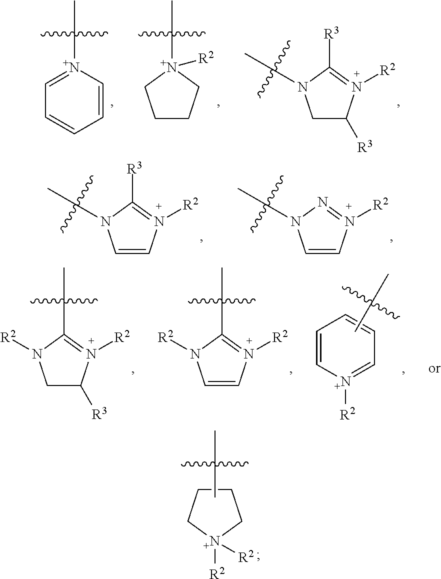

A⁻ can be F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; Y¹ and Y² can be independently —O—, —S—, —CH₂—, or —NH—; R^{a} and R^{b} can be independently hydrogen, or C₁₋₈ alkyl group; R¹ can be C₁₋₁₀ alkyl group or C₅₋₆ cycloalkyl group; i, j, and k can be independently 0, or an integer from 1 to 6; and, R² and R³ can be independently hydrogen, C₁₋₈ alkyl group, vinyl group, C₆₋₁₂ aryl group, or allyl group.

According to another embodiment of the disclosure, the disclosure provides an ion exchange membrane including a polymer or a cross-linking polymer, wherein the polymer can be the aforementioned polymer; the cross-linking polymer can be a reaction product of the aforementioned polymer and a cross-linking agent; and the cross-linking agent is a compound having at least two imide groups. The ion exchange membrane can have a thickness from 15 μm to 200 μm.

According to other embodiments of the disclosure, the disclosure provides a structural enhanced membrane including a polymer or a cross-linking polymer, and a substrate. The polymer can be the aforementioned polymer; the cross-linking polymer can be a reaction product of the aforementioned polymer and a cross-linking agent; and the cross-linking agent is a compound having at least two imide groups. The substrate can have a plurality of pores.

A detailed description is given in the following embodiments with reference to the accompanying drawings.

### BRIEF DESCRIPTION OF THE DRAWINGS

FIG. 1A is a schematic view of a substrate according to an embodiment of the disclosure;

FIG. 1B is a cross-sectional view of the structural enhanced membrane according to an embodiment of the disclosure; and

FIG. 2 to FIG. 4 are cross-sectional views of the structural enhanced membranes according to embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

The disclosure provides a polymer. The polymer of the disclosure can be a polymer with a cationic group and a non-ionic group. In the design of the chemical structure, in order to enhance the electrical conductivity of the polymer, the polymer of the disclosure has a repeating unit with a cationic group. In addition, the polymer of the disclosure has a repeating unit with a non-ionic group, in order to prevent the solubility of the polymer having cationic groups from decreasing when dissolving in a solvent. According to embodiments of the disclosure, besides its high solubility, the polymer of the disclosure exhibits improved mechanical strength and increased solvent selectivity.

According to embodiments of the disclosure, the polymer of the disclosure includes a first repeating unit and a second repeating unit. The first repeating unit can be

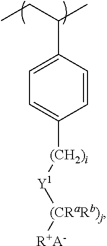

wherein R⁺ can be

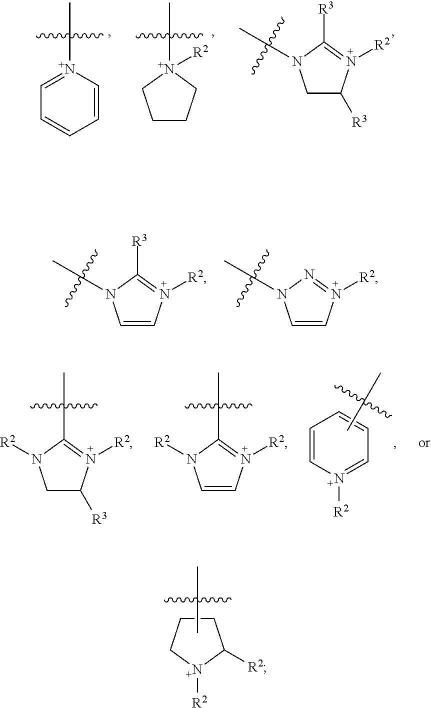

A⁻ can be F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; Y¹ can be —O—, —S—, —CH₂—, or —NH—; R^{a} and R^{b} can be independently hydrogen, or C₁₋₈ alkyl group (such as methyl, ethyl, propyl, isopropyl, n-butyl, sec-butyl, isobutyl, tert-butyl, pentyl, hexyl, heptyl, or octyl); i and j can be independently 0, or an integer from 1 to 6; and, R² and R³ can be independently hydrogen, C₁₋₈ alkyl group (such as methyl, ethyl, propyl, isopropyl, n-butyl, sec-butyl, isobutyl, tert-butyl, pentyl, hexyl, heptyl, or octyl), vinyl group, C₆₋₁₂ aryl group, or allyl group. The second repeating unit can be

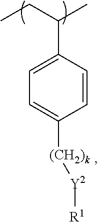

wherein Y² can be —O—, —S—, —CH₂—, or —NH—; k can be 0, or an integer from 1 to 6; and, R¹ can be C₁₋₁₀ alkyl group (such as methyl, ethyl, propyl, isopropyl, butyl, sec-butyl, isobutyl, tert-butyl, pentyl, sec-pentyl, isopentyl, neopentyl, hexyl, sec-hexyl, heptyl, sec-heptyl, octyl, sec-octyl, nonyl, decyl, 1-ethylpentyl, 2-ethylhexyl, or 2-butylhexyl) or C₅₋₆ cycloalkyl group (such as cyclopentyl or cyclohexyl).

According to embodiments of the disclosure, the first repeating unit can be

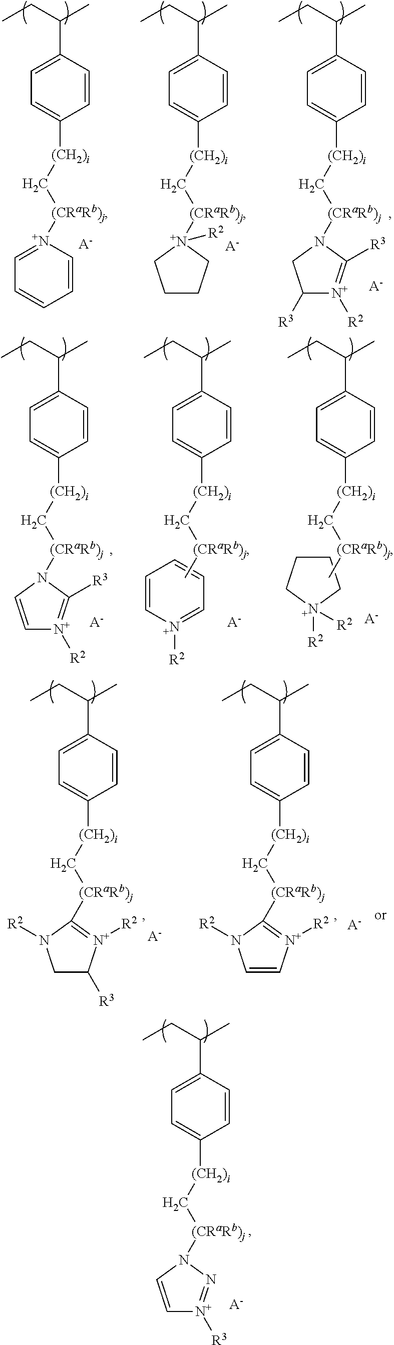

wherein A⁻ is F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; R^{a} and R^{b} are independently hydrogen, or C₁₋₈ alkyl group; i and j are independently 0, or an integer from 1 to 6; and, R² and R³ are independently hydrogen, C₁₋₈ alkyl group, vinyl group, C₆₋₁₂ aryl group, or allyl group.

According to embodiments of the disclosure, the first repeating unit can be

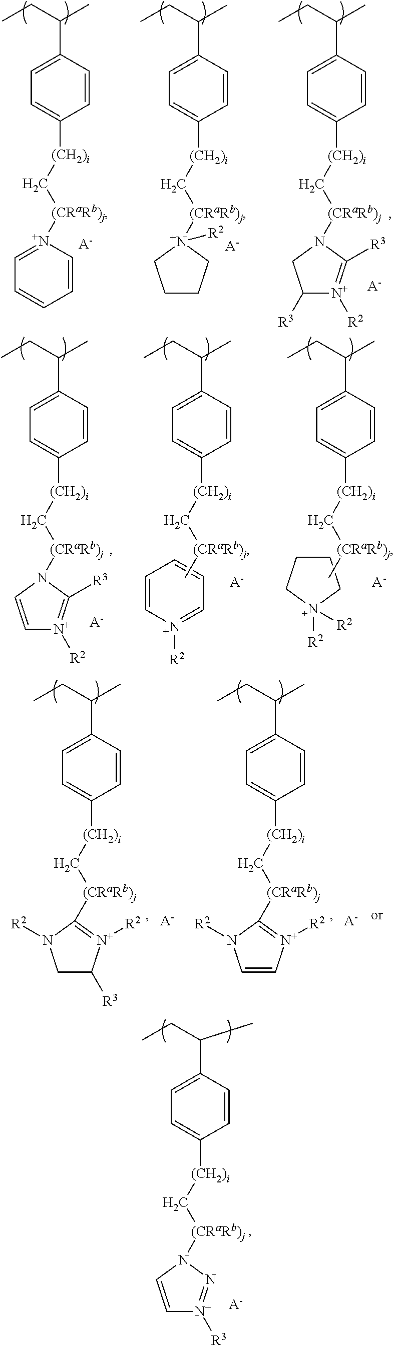

wherein A⁻ is F⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; R^{a} and R^{b} are independently hydrogen, or C₁₋₈ alkyl group; i and j are independently 0, or an integer from 1 to 6; and, R² and R³ are independently hydrogen, C₁₋₈ alkyl group, vinyl group, C₆₋₁₂ aryl group, or allyl group.

According to embodiments of the disclosure, the first repeating unit can be

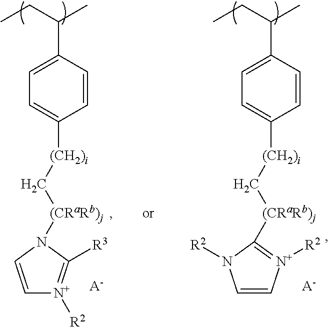

wherein A⁻ is F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; Y¹ is —O—, —S—, —CH₂—, or —NH—; R^{a} and R^{b} are independently hydrogen, or C₁₋₈ alkyl group; i and j are independently 0, or an integer from 1 to 6; and, R² and R³ are independently hydrogen, C₁₋₈ alkyl group, vinyl group, C₆₋₁₂ aryl group, or allyl group.

According to some embodiments of the disclosure, the second repeating unit can be

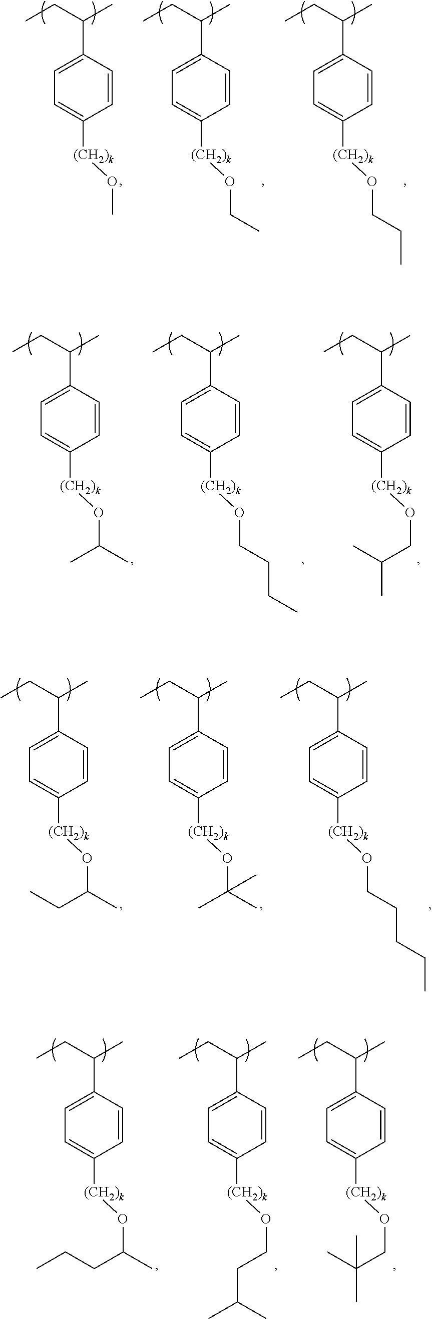

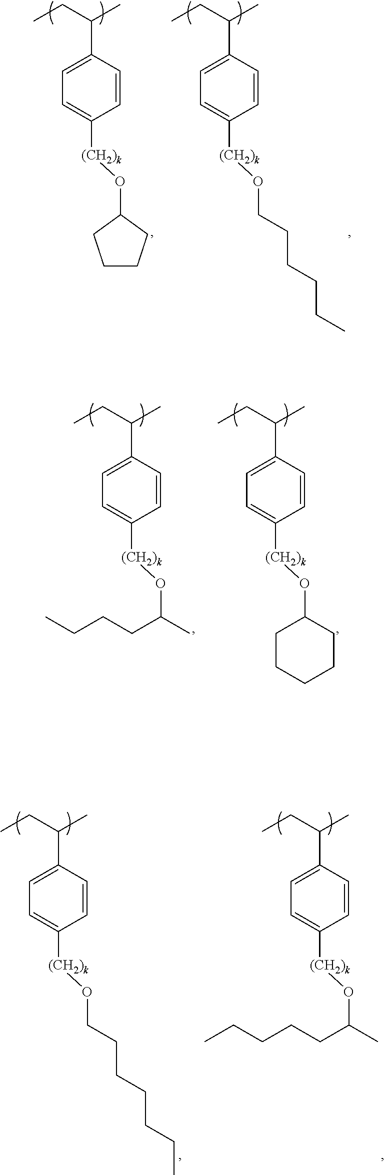

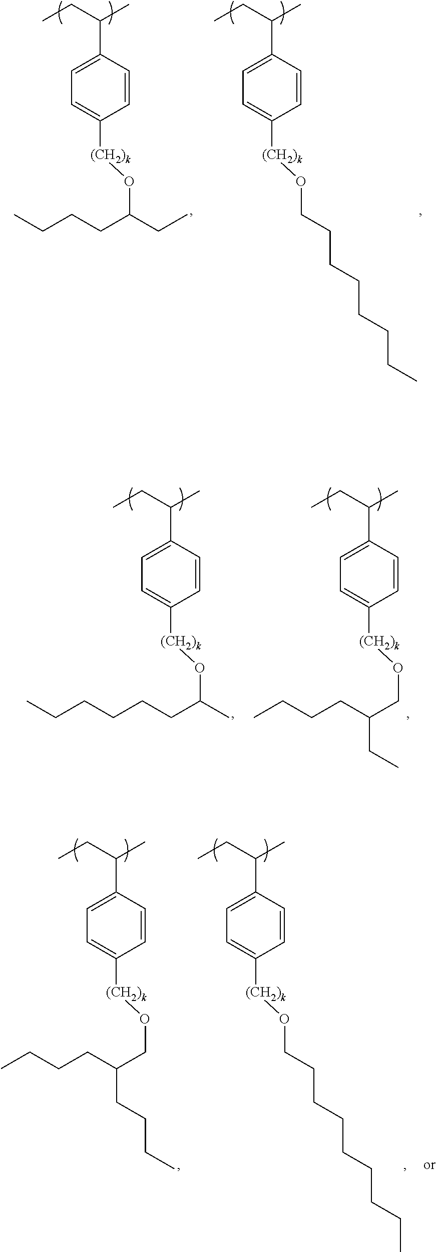

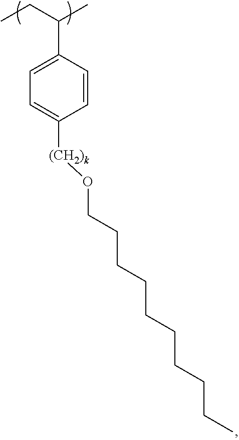

wherein k is 0, or an integer from 1 to 6.

According to embodiments of the disclosure, the ratio between the first repeating unit and the second repeating unit of the polymer can be adjusted to achieve the desired characteristics of the polymer. For example, the ratio between the first repeating unit and the second repeating unit can be increased in order to enhance the electrical conductivity and the anion exchange capacity of the polymer. Furthermore, the ratio between the first repeating unit and the second repeating unit can be decreased in order to enhance the solubility, the mechanical strength, and the solvent selectivity of the polymer. The ratio between the first repeating unit and the second repeating unit can be from about 1:99 to 99:1, such as from about 10:90 to 90:10, from about 20:80 to 80:20, or from about 30:70 to 70:30. Furthermore, the polymer has a molecular weight (such as weight average molecular weight) from about 5,000 to 500,000, such as from about 10,000 to 300,000.

The first repeating unit and the second repeating unit can be arranged in a regular or random fashion by means of the synthetic method. For example, the polymer including the first repeating unit and the second repeating unit can be a block polymer. The synthetic method of the polymer can be reversible addition-fragmentation transfer (RAFT) reaction, nitroxide-mediated radical polymerization (NMRP), or atom transfer radical polymerization (ATRP). When the synthetic method is the reversible addition-fragmentation transfer (RAFT) reaction, an initiator and/or a chain transfer agent can be utilized to facilitate the polymerization. The initiator can be azobisisobutyronitrile, (AIBN), and the chain transfer agent can be dithioester or trithioester chain transfer agent (such as 1-phenylethyl tetradecyl carbonotrithioate (having a structure represented by

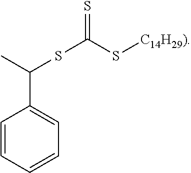

According to embodiments of the disclosure, the polymer or the cross-linking polymer of the disclosure may be applied in the preparation of an ion exchange membrane. The ion exchange membrane of the disclosure can be made of the polymer of the disclosure. Furthermore, the ion exchange membrane of the disclosure can be made of a cross-linking polymer which is a reaction product of the polymer of the disclosure and a cross-linking agent via a cross-linking reaction. According to some embodiments of the disclosure, the method for fabricating the ion exchange membrane includes the following steps. First, a composition is provided, wherein the composition includes the aforementioned polymer and the aforementioned cross-linking agent. Furthermore, the composition further includes a solvent, and the composition has a solid content between about 5 wt % and 50 wt %. In the composition, the cross-linking agent has a weight percentage between about 1 wt % and 30 wt % (such as between about 5 wt % and 30 wt %, or between about 3 wt % and 25 wt %), based on the weight of the polymer. Next, the composition is mixed and dispersed, and coated on a substrate (such as a glass substrate) to form a coating. Next, the coating is baked at a high temperature to remove most of the solvent. Next, the coating is baked in a relatively high-temperature oven to remove residual solvent, obtaining the ion exchange membrane. The ion exchange membrane can have a thickness from about 15 μm to 200 μm, such as from about 30 μm to 100 μm.

According to another embodiment, the method for fabricating the ion exchange membrane can include the following steps. First, the polymer is dissolved in a solvent to obtain a solution. Next, the solution is coated on a substrate (such as a glass substrate) to form a coating. Next, the coating is baked at a high temperature to remove most of the solvent. Next, the coating is baked in a relatively high-temperature oven to remove residual solvent, obtaining the ion exchange membrane. The ion exchange membrane can have a thickness from about 15 μm to 200 μm, such as from about 30 μm to 100 μm.

According to embodiments of the disclosure, the cross-linking agent can be a compound having at least two imide groups, wherein the imide group can be phthalimide group, succinimide group, N-bromosuccinimide group, glutarimide, or maleimide group. For example, the cross-linking agent can be a compound having at least two maleimide groups (such as a compound having two maleimide groups). According to embodiments of the disclosure, the compound having two maleimide groups can be

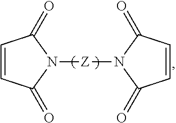

wherein Z can be

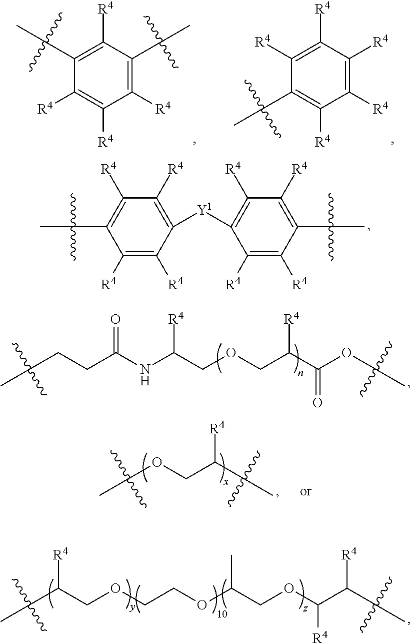

wherein Y¹ can be single bond, —O—, —S—, —CH₂—, or —NH—, R₄ can be independently hydrogen, or C₁₋₄ alkyl group; n≧1; x can be an integer from 1 to 12, y and z can be independently an integer from 1 to 5. For example, the cross-linking agent can be

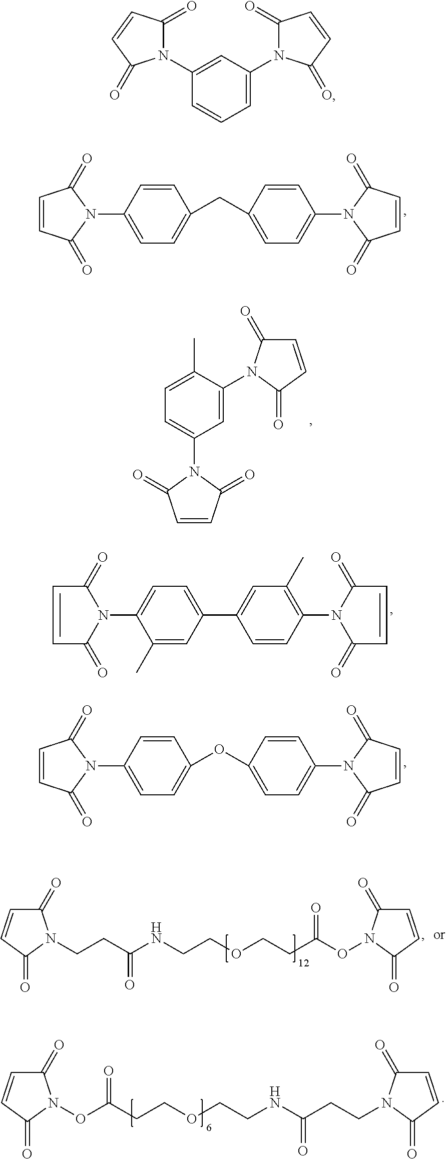

In addition, according to embodiments of the disclosure, the cross-linking agent can be a polymeric cross-linking agent having at least two maleimide groups. The polymeric cross-linking agent can be a reaction product of a compound (a) and a compound (b). The compound (a) can be

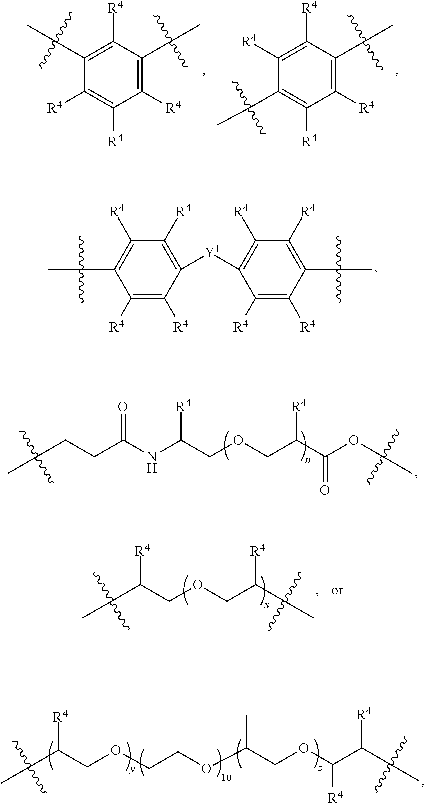

wherein Z can be

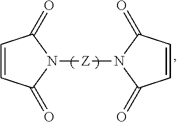

wherein Y¹ can be single bond, —O—, —S—, —CH₂—, or —NH—, R₄ can independently hydrogen, or C₁₋₄ alkyl group; and, n≧1; x can be an integer from 1 to 12; and, y and z can be independently an integer from 1 to 5. The compound (b) can be a compound represented by Formula (I) or Formula (II)

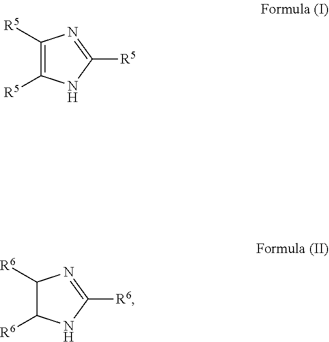

wherein R⁵ is independently hydrogen, or C₁₋₄ alkyl group; and, R⁶ is independently hydrogen, or C₁₋₄ alkyl group. For example, the compound (b) can be

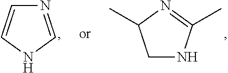

The polymeric cross-linking agent and the polymer can form an interpenetrating polymer network, thereby enhancing the mechanical strength and dimensional stability.

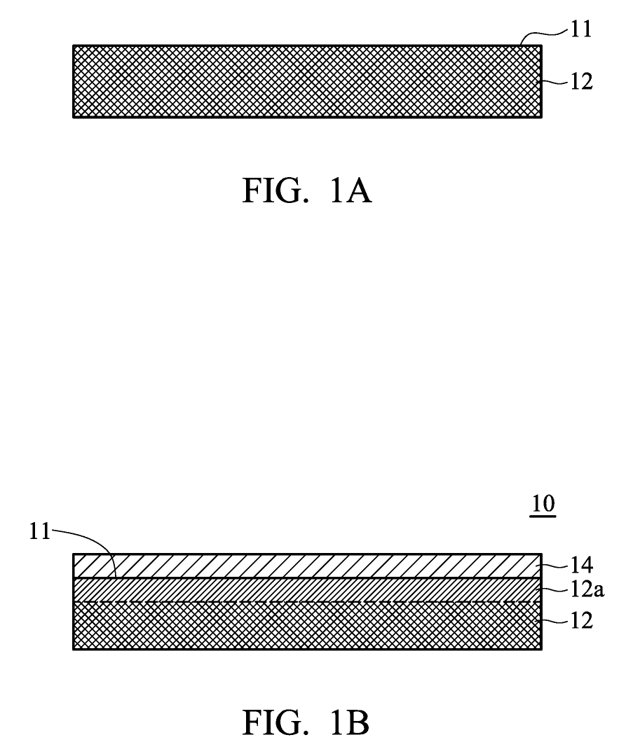

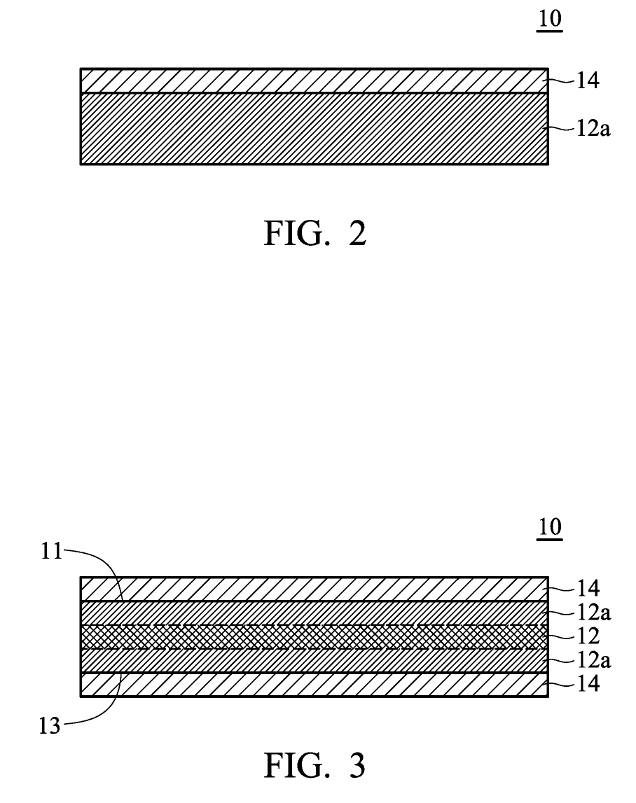

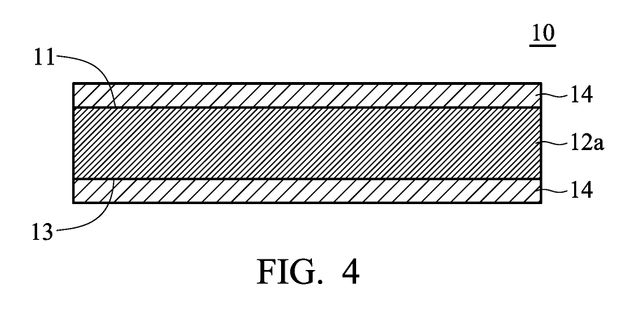

According to embodiments of the disclosure, the polymer or the cross-linking polymer of the disclosure may be applied in the preparation of a structural enhanced membrane in order to form a membrane with a composite structure. According to an embodiment of the disclosure, the structural enhanced membrane can include the aforementioned polymer or the aforementioned cross-linking polymer and a substrate. The substrate can have a plurality of pores. The polymer or the cross-linking polymer of the disclosure can be disposed on a surface of the substrate and filled into the pores of the substrate. In detail, the method for fabricating the structural enhanced membrane can include the following steps. First, a substrate 12 is provided, wherein the substrate 12 can have a plurality of pores and a first surface 11, as shown in FIG. 1A. Next, a composition including the polymer or the cross-linking polymer is coated on the first surface 11 of the substrate 12 to form a polymer or a cross-linking polymer layer 14. In particular, since the substrate 12 has a plurality of pores, a part of the polymer or the cross-linking polymer can infiltrate into the substrate 12 via the pores, such that the part of the substrate 12, which is infiltrated by the polymer or the cross-linking polymer, becomes a composite layer 12a, obtaining the structural enhanced membrane 10 of the disclosure, as shown in FIG. 1B. According to another embodiment of the disclosure, when the substrate 12 has a relatively low thickness or the composition including the polymer or the cross-linking polymer has a relatively low viscosity (i.e. the polymer or the cross-linking polymer is dissolved in a solvent to form a solution including the polymer or cross-linking polymer, wherein the solvent can be dimethylacetamide (DMAc), dimethyl sulfoxide (DMSO), N-methyl-2-pyrrolidone (NMP), methanol (MeOH), or butanol (BuOH)), a part of the polymer or the cross-linking polymer can infiltrate into the whole substrate 12 via the pores, such that the whole substrate 12 becomes the composite layer 12a. Therefore, the structural enhanced membrane 10 consists of the polymer or the cross-linking polymer layer 14 and the composite layer 12a, as shown in FIG. 2. Furthermore, according to embodiments of the disclosure, the substrate 12 can have a second surface 13 opposite to the first surface 11, and the composition including the polymer or the cross-linking polymer can be coated on the first surface 11 and the second surface 13 simultaneously, thus one polymer or cross-linking polymer layer 14 and the other polymer or cross-linking polymer layer 14 are formed on the first surface 11 and the second surface 13 respectively, obtaining the structural enhanced membrane 10 of the disclosure, as shown in FIG. 3 and FIG. 4. It should be noted that the material of the polymer or cross-linking polymer layer 14 formed on the first surface 11 and the material of the polymer or cross-linking polymer layer 14 formed on the second surface 13 can be the same or different. Suitable materials for the substrate 12 can be polytetrafluoroethene (PTFE), polyimide (PI), polyethylene terephthalate (PET), polyether ether ketone (PEEK), polypropylene (PP), polyethylene (PE), polyvinylidene fluoride (PVDF), or a combination thereof. The structural enhanced membrane can serve as a complexion exchange membrane of a fuel battery, a single ion conductor membrane of a lithium-ion battery, or an ion conducting membrane or separator used in electrolytic hydrogen production or a water treatment process.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

Preparation of Polymer

### Example 1

0.0973 g of 1-phenylethyl tetradecyl carbonotrithioate (0.237 mmole), 10.01 g of vinylbenzylimidazolium chloride ([MVBIM]Cl, having a structure represented by

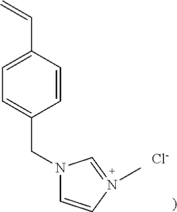

(42.66 mmole), 0.90 g of vinylbenzylbutyl ether (VBOBu, having a structure represented by

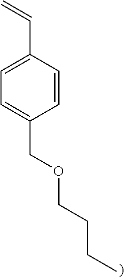

(4.74 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (1) (having a repeating unit represented by

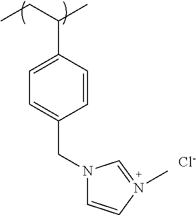

and a repeating unit represented by

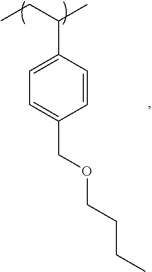

wherein the ratio of the repeating unit represented by

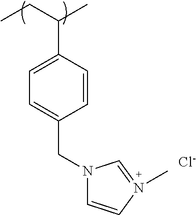

and the repeating unit represented by

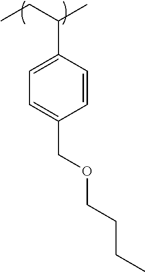

was about 90:10). After measurement, the weight average molecular weight (Mw) of Polymer (1) is about 25,345.

Polymer (1) was analyzed by nuclear magnetic resonance (NMR) spectroscopy and the result is as follows: ¹H NMR (DMSO-d₆, 500 MHz) δ 10.02 (br), 7.76 (br), 6.62-7.45 (br), 6.40 (br), 5.42 (br), 4.28 (br), 3.84 (br), 0.78 (br).

### Example 2

0.0973 g of 1-phenylethyl tetradecyl carbonotrithioate (0.237 mmole), 6.67 g of vinylbenzylimidazolium chloride ([MVBIM]Cl) (28.44 mmole), 3.61 g of vinylbenzylbutyl ether (VBOBu) (18.97 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (2) (having a repeating unit represented by

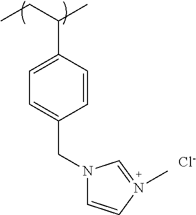

and a repeating unit represented by

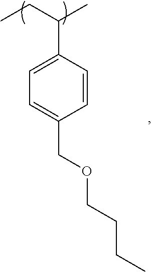

wherein the ratio of the repeating unit represented by

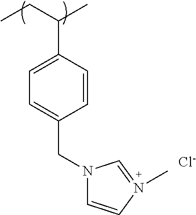

and the repeating unit represented by

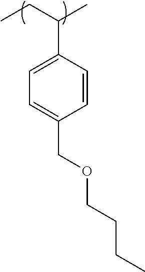

was about 60:40). After measurement, the weight average molecular weight (Mw) of Polymer (2) is about 75,040.

Polymer (2) was analyzed by nuclear magnetic resonance (NMR) spectroscopy and the result is as follows: ¹H NMR (DMSO-d₆, 500 MHz) δ 9.92 (br), 7.76 (br), 6.63-7.54 (br), 6.39 (br), 5.42 (br), 4.33 (br), 3.85 (br), 0.82 (br).

### Example 3

0.0973 g of 1-phenylethyl tetradecyl carbonotrithioate (0.237 mmole), 2.78 g of vinylbenzylimidazolium chloride ([MVBIM]Cl) (11.85 mmole), 6.75 g of vinylbenzylbutyl ether (VBOBu) (35.55 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (3) (having a repeating unit represented by

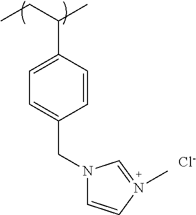

and a repeating unit represented by

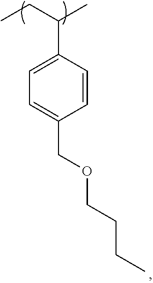

wherein the ratio of the repeating unit represented by

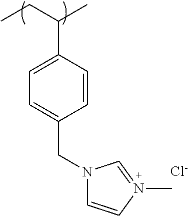

and the repeating unit represented by

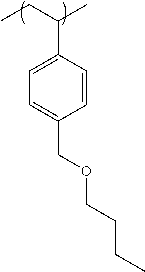

was about 25:75). After measurement, the weight average molecular weight (Mw) of Polymer (3) is about 62,787.

Polymer (3) was analyzed by nuclear magnetic resonance (NMR) spectroscopy and the result is as follows: ¹H NMR (DMSO-d₆, 500 MHz) δ 9.43 (br), 7.68 (br), 6.96 (br), 6.41 (br), 5.30 (br), 4.31 (br), 3.82 (br), 0.81 (br).

### Example 4

0.0973 g of 1-phenylethyl tetradecyl carbonotrithioate (0.237 mmole), 1.11 g of vinylbenzylimidazolium chloride ([MVBIM]Cl) (4.74 mmole), 8.11 g of vinylbenzylbutyl ether (VBOBu) (42.62 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (4) (having a repeating unit represented by

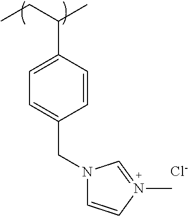

and a repeating unit represented by

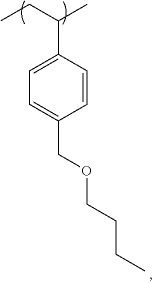

wherein the ratio of the repeating unit represented by

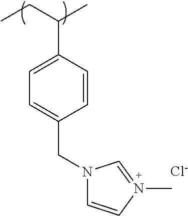

and the repeating unit represented by

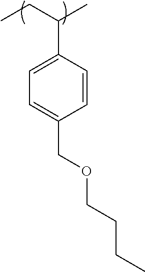

was about 10:90).

Polymer (4) was analyzed by nuclear magnetic resonance (NMR) spectroscopy and the result is as follows: ¹H NMR (DMSO-d₆, 500 MHz) δ 9.25 (br), 7.63 (br), 6.98 (br), 6.40 (br), 5.28 (br), 4.30 (br), 3.80 (br), 0.81 (br).

### Example 5

0.0973 g of 1-phenylethyl tetradecyl carbonotrithioate (0.237 mmole), 6.75 g of vinylbenzylbutyl ether (VBOBu) (35.55 mmole), and 9.72 mg of azobisisobutyronitrile (AIBN) (0.059 mmole) were added into a reaction bottle under a nitrogen atmosphere. Next, 20 ml of tetrahydrofuran (THF) was added into the reaction bottle, and the reaction bottle was heated to 100° C. After stirring for 72 hours and concentration, the result was washed with methanol, and then the solid was collected, obtaining poly([VBOBu]) polymer. Next, poly([VBOBu]) polymer, 2.78 g of vinylbenzylimidazolium chloride ([MVBIM]Cl) (11.85 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (5) (having a polymeric block represented by

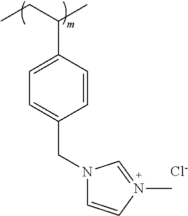

(m>1) and a polymeric block represented by

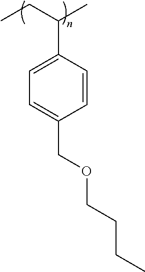

(n>1), wherein the ratio of the repeating unit represented by

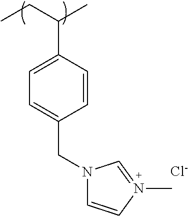

and the repeating unit represented by

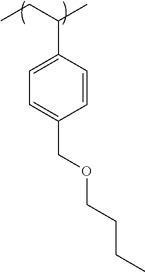

was about 25:75). After measurement, the weight average molecular weight (Mw) of Polymer (5) is about 42,700.

Polymer (5) was analyzed by nuclear magnetic resonance (NMR) spectroscopy and the result is as follows: ¹H NMR (DMSO-d₆, 500 MHz) δ 9.63 (br), 7.75 (br), 6.97 (br), 6.40 (br), 5.27 (br), 4.29 (br), 3.82 (br), 0.78 (br).

### Example 6

0.0973 g of 1-phenylethyl tetradecyl carbonotrithioate (0.237 mmole), 6.67 g of vinylbenzylimidazolium chloride ([MVBIM]Cl) (28.44 mmole), 4.67 g of vinylbenzyloctyl ether (VBOOc, having a structure represented by

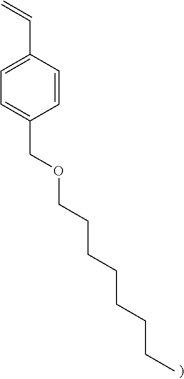 [SMILES: C=Cc1ccc(COCCCCCCCC)cc1]

(18.96 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (6) (having a repeating unit represented by

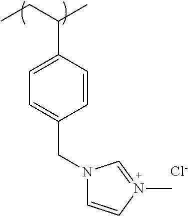

and a repeating unit represented by

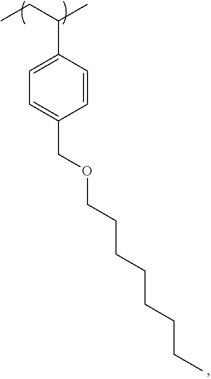

wherein the ratio of the repeating unit represented by

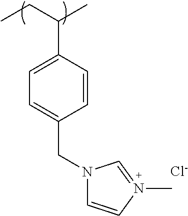

and the repeating unit represented by

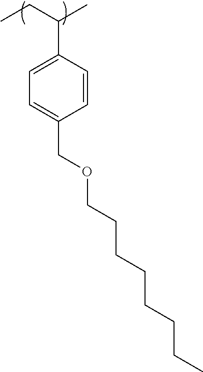

was about 60:40). After measurement, the weight average molecular weight (Mw) of Polymer (6) is about 153,507.

Polymer (6) was analyzed by nuclear magnetic resonance (NMR) spectroscopy and the result is as follows: ¹H NMR (DMSO-d₆, 500 MHz) δ 9.83 (br), 7.75 (br), 7.22 (br), 6.39 (br), 5.42 (br), 4.33 (br), 3.86 (br), 3.26 (br), 0.76 (br).

### Example 7

0.0973 g of 1-phenylethyl tetradecyl carbonotrithioate (0.237 mmole), 7.79 g of vinylbenzylimidazolium chloride ([MVBIM]Cl) (33.18 mmole), 3.5 g of vinylbenzyl-(2-ethyl)hexyl ether (VBOEH, having a structure represented by

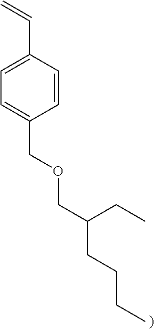 [SMILES: C=Cc1ccc(COCC(CC)CCCC)cc1]

(14.22 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (7) (having a repeating unit represented by

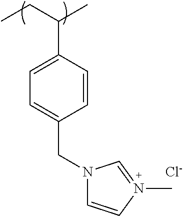

and a repeating unit represented by

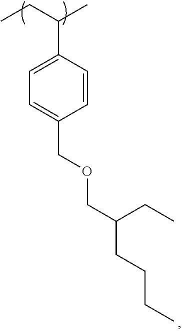

wherein the ratio of the repeating unit represented by

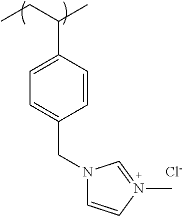

and the repeating unit represented by

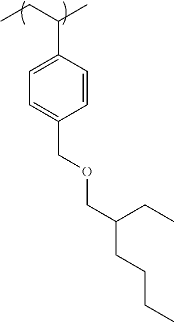

was about 70:30). After measurement, the weight average molecular weight (Mw) of Polymer (7) is about 74,648.

Polymer (7) was analyzed by nuclear magnetic resonance (NMR) spectroscopy and the result is as follows: ¹H NMR (DMSO-d₆, 500 MHz) δ 9.74 (br), 7.73 (br), 7.29 (br), 6.37 (br), 5.43 (br), 4.33 (br), 3.86 (br), 3.23 (br), 0.75 (br).

### Example 8

0.0973 g of 1-phenylethyl tetradecyl carbonotrithioate (0.237 mmole), 5.9 g of 3-butyl-1-(4-vinylbenzyl)-1H-imidazol-3-ium chloride ([BVBIM]Cl, having a structure represented by

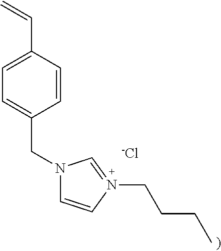

(21.33 mmole), 3.61 g of vinylbenzylbutyl ether (VBOBu, having a structure represented by

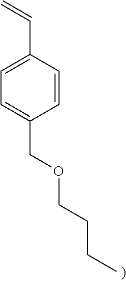

(18.96 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (8) (having a repeating unit represented by

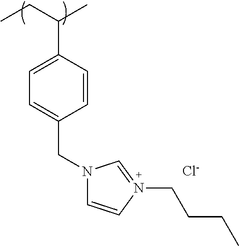

and a repeating unit represented by

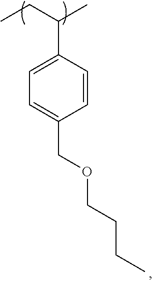

wherein the ratio of the repeating unit represented by

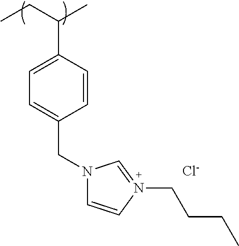

and the repeating unit represented by

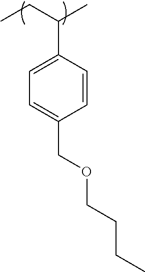

was about 45:55). After measurement, the weight average molecular weight (Mw) of Polymer (8) is about 117,200.

Polymer (8) was analyzed by nuclear magnetic resonance (NMR) spectroscopy and the result is as follows: ¹H NMR (DMSO-d₆, 500 MHz) δ 9.86 (br), 7.83 (br), 6.99 (br), 6.42 (br), 5.37 (br), 4.32 (br), 4.10 (br), 3.17 (br), 0.87 (br).

### Example 9

0.0973 g of 1-phenylethyl tetradecyl carbonotrithioate (0.237 mmole), 7.87 g of 3-butyl-1-(4-vinylbenzyl)-1H-imidazol-3-ium chloride ([BVBIM]Cl) (28.44 mmole), 3.61 g of vinylbenzylbutyl ether (VBOBu) (18.96 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (9) (having a repeating unit represented by

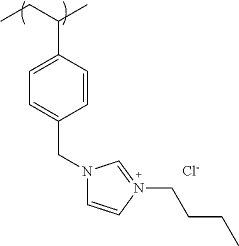

and a repeating unit represented by

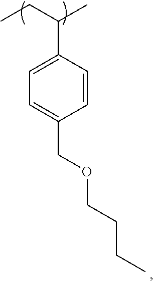

wherein the ratio of the repeating unit represented by

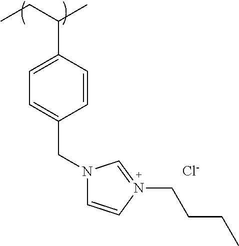

and the repeating unit represented by

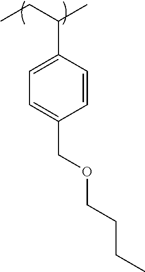

was about 60:40). After measurement, the weight average molecular weight (Mw) of Polymer (9) is about 135,966.

Polymer (9) was analyzed by nuclear magnetic resonance (NMR) spectroscopy and the result is as follows: ¹H NMR (DMSO-d₆, 500 MHz) δ 9.96 (br), 7.84 (br), 6.68-7.57 (br), 6.43 (br), 5.42 (br), 4.33 (br), 4.18 (br), 0.80 (br).

### Example 10

0.0973 g of 1-phenylethyl tetradecyl carbonotrithioate (0.237 mmole), 9.18 g of 3-butyl-1-(4-vinylbenzyl)-1H-imidazol-3-ium chloride ([BVBIM]Cl) (33.18 mmole), 2.71 g of vinylbenzylbutyl ether (VBOBu) (14.22 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (10) (having a repeating unit represented by

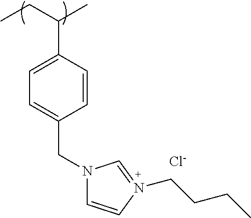

and a repeating unit represented by

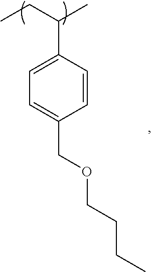

wherein the ratio of the repeating unit represented by

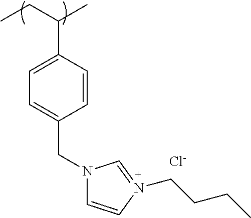

and the repeating unit represented by

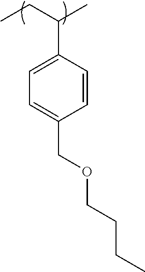

was about 70:30). After measurement, the weight average molecular weight (Mw) of Polymer (10) is about 262,100.

Polymer (10) was analyzed by nuclear magnetic resonance (NMR) spectroscopy and the result is as follows: ¹H NMR (DMSO-d₆, 500 MHz) δ 10.08 (br), 7.86 (br), 6.70-7.58 (br), 6.37 (br), 5.44 (br), 4.33 (br), 4.16 (br), 0.79 (br).

### Example 11

0.0973 g of 1-phenylethyl tetradecyl carbonotrithioate (0.237 mmole), 9.18 g of 3-butyl-1-(4-vinylbenzyl)-1H-imidazol-3-ium chloride ([BVBIM]Cl) (33.18 mmole), 3.5 g of vinylbenzyl-(2-ethyl)hexyl ether (VBOEH, having a structure represented by

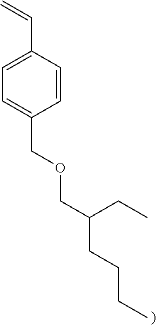 [SMILES: C=Cc1ccc(COCC(CC)CCCC)cc1]

(14.22 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (11) (having a repeating unit represented by

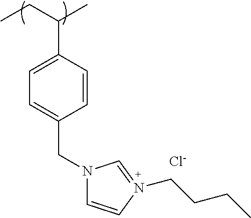

and a repeating unit represented by

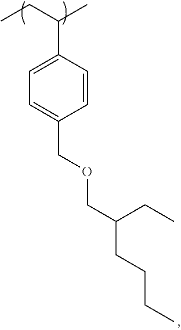

wherein the ratio of the repeating unit represented by

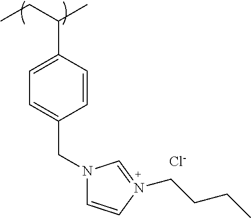

and the repeating unit represented by

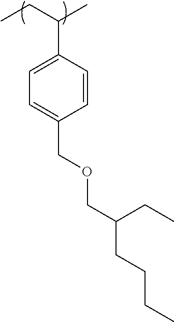

was about 70:30). After measurement, the weight average molecular weight (Mw) of Polymer (11) is about 138,010.

Polymer (11) was analyzed by nuclear magnetic resonance (NMR) spectroscopy and the result is as follows: ¹H NMR (DMSO-d₆, 500 MHz) δ 10.03 (br), 7.85 (br), 6.66-7.57 (br), 6.35 (br), 5.43 (br), 4.34 (br), 4.18 (br), 3.23 (br), 0.75 (br).

### Example 12

0.0973 g of 1-phenylethyl tetradecyl carbonotrithioate (0.237 mmole), 10.18 g of 1,3-dimethyl-2-(2-((4-vinylbenzyl)oxy)propan-2-yl)-1H-imidazol-3-ium chloride ([MVBCIM]Cl, having a structure represented by

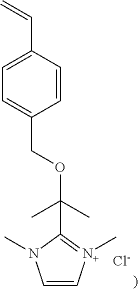 [SMILES: C=Cc1ccc(COC(C)(C)c2n(C)cc[n+]2C)cc1 ; [Cl-]]

(33.18 mmole), 2.71 g of vinylbenzylbutyl ether (VBOBu, having a structure represented by

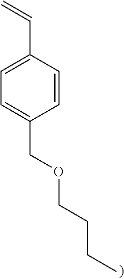

(14.22 mmole), and 9.72 mg of azobisisobutyronitrile (AIBN) (0.059 mmole) were added into a reaction bottle under a nitrogen atmosphere. Next, 20 ml of methanol was added into the reaction bottle, and the reaction bottle was heated to 100° C. After stirring for 72 hours and concentration, the result was washed with ether, and then the solid was collected, obtaining Polymer (12) (having a repeating unit represented by

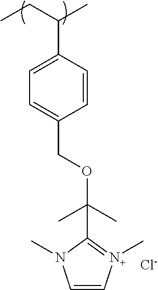

and a repeating unit represented by

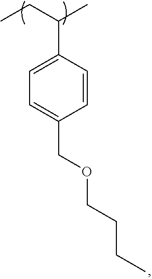

wherein the ratio of the repeating unit represented by

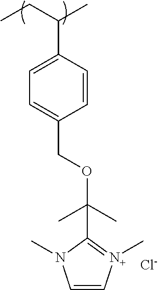

and the repeating unit represented by

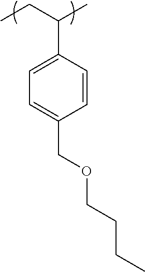

was about 70:30). After measurement, the weight average molecular weight (Mw) of Polymer (12) is about 16,172.

Polymer (12) was analyzed by nuclear magnetic resonance (NMR) spectroscopy and the result is as follows: ¹H NMR (DMSO-d₆, 500 MHz) δ 7.75 (br), 6.10-7.52 (br), 5.09 (br), 4.34 (br), 3.98 (br).

Preparation of Cross-Linking Agent

### Preparation Example 1

2.73 g of

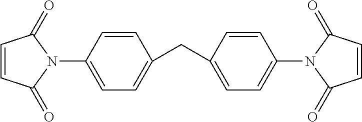 [SMILES: O=C1C=CC(=O)N1c1ccc(Cc2ccc(N3C(=O)C=CC3=O)cc2)cc1]

and 0.37 g of

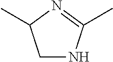

were added into a reaction bottle, wherein the molar ratio of the

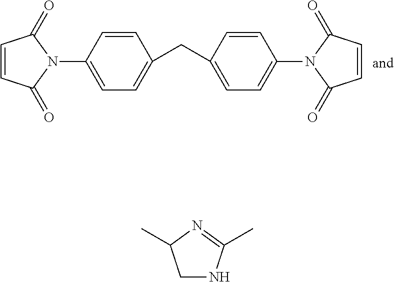

was 2:1). Next, 97 g of dimethylacetamide (DMAc) was added into the reaction bottle. After stirring at 100-150° C. for 5-10 hours, Polymeric cross-linking agent (1) was obtained.

Preparation of Anion Exchange Membrane

### Example 13

100 parts by weight of Polymer (2) (prepared in Example 2) was added into a reaction bottle, and dissolved in 567 parts by weight of dimethylacetamide (DMAc). Next, 10 parts by weight of Polymeric cross-linking agent (1) (prepared from Preparation Example 1) was added into the reaction bottle. Next, the result was mixed and distributed via a high-speed homogenizer, and then defoamed, obtaining a solution. Next, the solution was coated on a glass substrate via spin coating, forming a coating. Next, the coating was baked at 40-150° C. to remove most of the solvent. Next, the coating was baked at 120-200° C. for 1-6 hours to remove residual solvent, and Anion exchange membrane (1) was obtained. Next, the ionic conductivity and the dimensional stability of Anion exchange membrane (1) were measured, and the result is shown in Table 1. The dimensional stability of Anion exchange membrane (1) was measured according to the Journal of Materials Chemistry A Materials for Energy and Sustainability 3 (23) (2015) 12284-12296 after immersing at 25° C. for 24 hours.

### Examples 14-17

Examples 14-17 were performed in the same manner as Example 13 except that Polymers (7), (9), (10) and (11) were substituted for Polymer (2) respectively, obtaining Anion exchange membranes (2)-(5). Next, the ionic conductivity and the dimensional stability of Anion exchange membranes (2)-(5) were measured, and the results are shown in Table 1. The dimensional stability of Anion exchange membranes (2)-(5) was measured according to the Journal of Materials Chemistry A Materials for Energy and Sustainability 3 (23) (2015) 12284-12296 after immersing at 25° C. for 24 hours.

### Example 18

100 parts by weight of Polymer (8) (prepared in Example 8) was added into a reaction bottle, and dissolved in 567 parts by weight of dimethyl sulfoxide (DMSO). Next, the result was defoamed, obtaining a solution. Next, the solution was coated on a glass substrate via spin coating, forming a coating. Next, the coating was baked at 40-150° C. to remove most of the solvent. Next, the coating was baked at 120-200° C. for 1-6 hours to remove residual solvent, and Anion exchange membrane (6) was obtained. Next, the ionic conductivity and the dimensional stability of Anion exchange membrane (6) were measured, and the result is shown in Table 1. The dimensional stability of Anion exchange membrane (6) was measured according to the Journal of Materials Chemistry A Materials for Energy and Sustainability 3 (23) (2015) 12284-12296 after immersing at 25° C. for 24 hours.

TABLE 1

| | | | ratio of the | | |
|---|---|---|---|---|---|
| | | | first repeating | | |
| | | | unit and | ionic | dimensional |
| | first | second | second | conductivity | stability |
| | repeating unit | repeating unit | repeating unit | (S/cm) | (%) |
| Anion exchange membrane (1) | 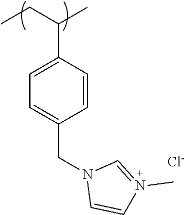 | 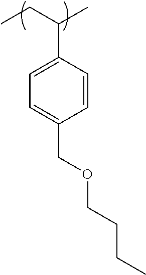 | 60:40 | 0.043 | 62.7 |
| Anion exchange membrane (2) | 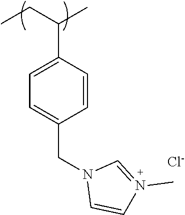 | 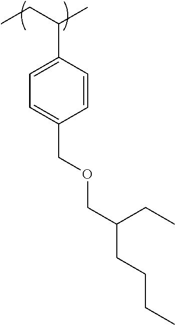 | 70:30 | 0.038 | 131.8 |
| Anion exchange membrane (3) | 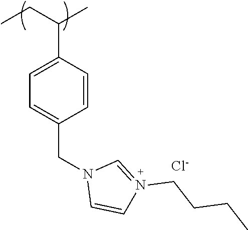 | 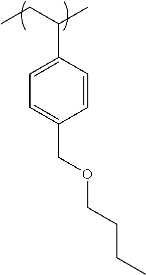 | 60:40 | 0.043 | 44.7 |
| Anion exchange membrane (4) | 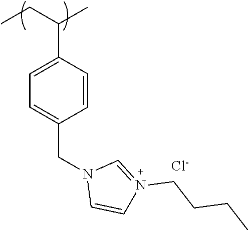 | 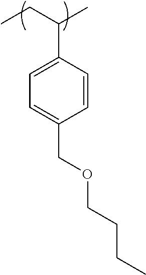 | 70:30 | 0.051 | 121.1 |
| Anion exchange membrane (5) | 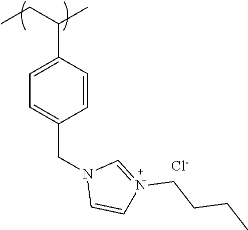 | 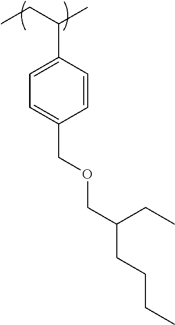 | 70:30 | 0.047 | 152.3 |
| Anion exchange membrane (6) | 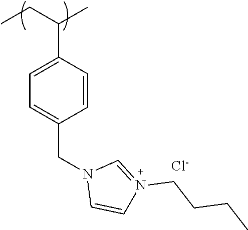 | 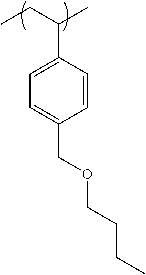 | 45:55 | 0.021 | 30.7 |

As shown in Table 1, with the increase of the ionic repeating unit (represented by

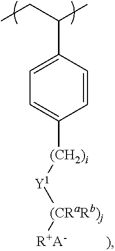

the ionic conductivity of the anion exchange membrane is increased. In addition, the anion exchange membrane of the disclosure also exhibits high dimensional stability.

Since the ion exchange membrane is prepared from a polymer with a stable cyclic conjugated cationic group (such as an imidazole group) and a cross-linking agent has at least two functional groups which can be reacted with the cyclic conjugated cationic group, the ion exchange membrane exhibits high film forming ability, ionic conductivity, mechanical strength, and dimensional stability. Hence, the ion exchange membrane is suitable for use in a fuel cell or a purification and separation device.

Accordingly, due to the introduction of a stably cationic group, the polymer of the disclosure exhibits high ionic conductivity. Furthermore, due to the simultaneous introduction of a non-ionic group, the polymer of the disclosure also exhibits high solubility, mechanical strength, and solvent selectivity.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A polymer, comprising a first repeating unit and a second repeating unit, wherein the first repeating unit is 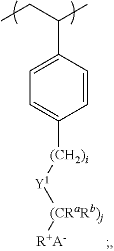
the second repeating unit is 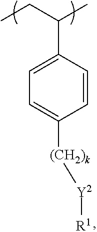
wherein R⁺ is 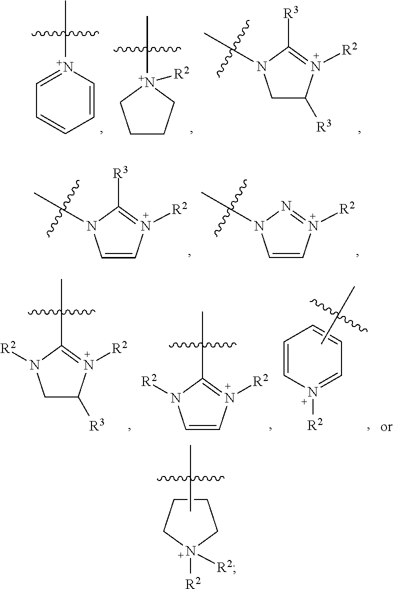
A⁻ is F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; Y¹ and Y² are independently —O—, —S—, —CH₂—, or —NH—; R^{a} and R^{b} are independently hydrogen, or C₁₋₈ alkyl group; R¹ is C₁₋₁₀ alkyl group or C₅₋₆ cycloalkyl group; i, j and k is independently 0, or an integer from 1 to 6; and, R² and R³ are independently hydrogen, C₁₋₈ alkyl group, vinyl group, C₆₋₁₂ aryl group, or allyl group.

2. The polymer as claimed in claim 1, wherein the ratio between the first repeating unit and the second repeating unit is from 1:99 to 99:1.

3. The polymer as claimed in claim 1, wherein R¹ is methyl, ethyl, propyl, isopropyl, butyl, sec-butyl, isobutyl, tert-butyl, pentyl, sec-pentyl, isopentyl, neopentyl, cyclopentyl, hexyl, sec-hexyl, cyclohexyl, heptyl, sec-heptyl, octyl, sec-octyl, nonyl, decyl, 1-ethylpentyl, 2-ethylhexyl, or 2-butylhexyl.

4. The polymer as claimed in claim 1, wherein the first repeating unit is 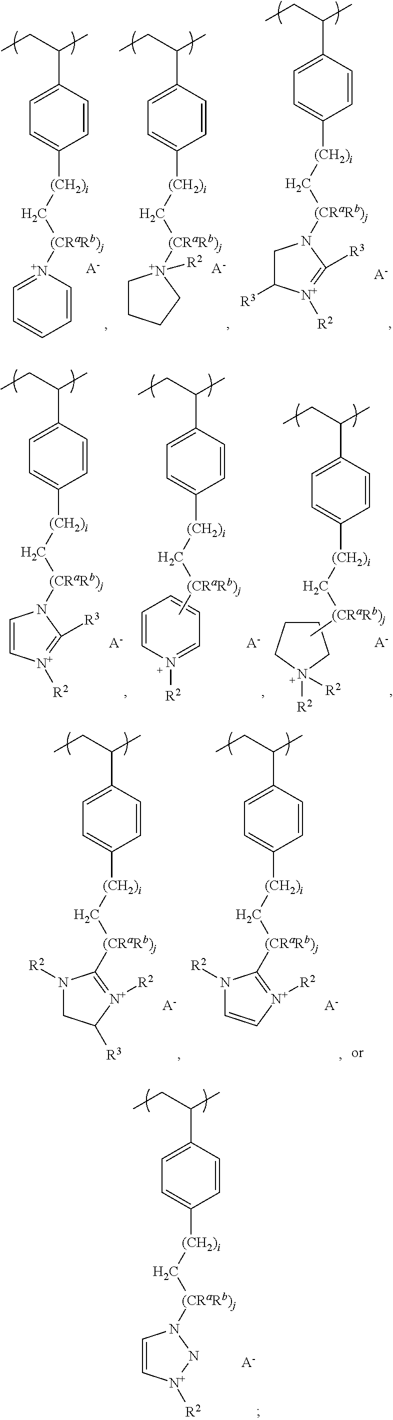
wherein A⁻ is F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; R^{a} and R^{b} are independently hydrogen, or C₁₋₈ alkyl group; i and j are independently 0, or an integer from 1 to 6; and, R² and R³ are independently hydrogen, C₁₋₈ alkyl group, vinyl group, C₆₋₁₂ aryl group, or allyl group.

5. The polymer as claimed in claim 1, wherein the first repeating unit is 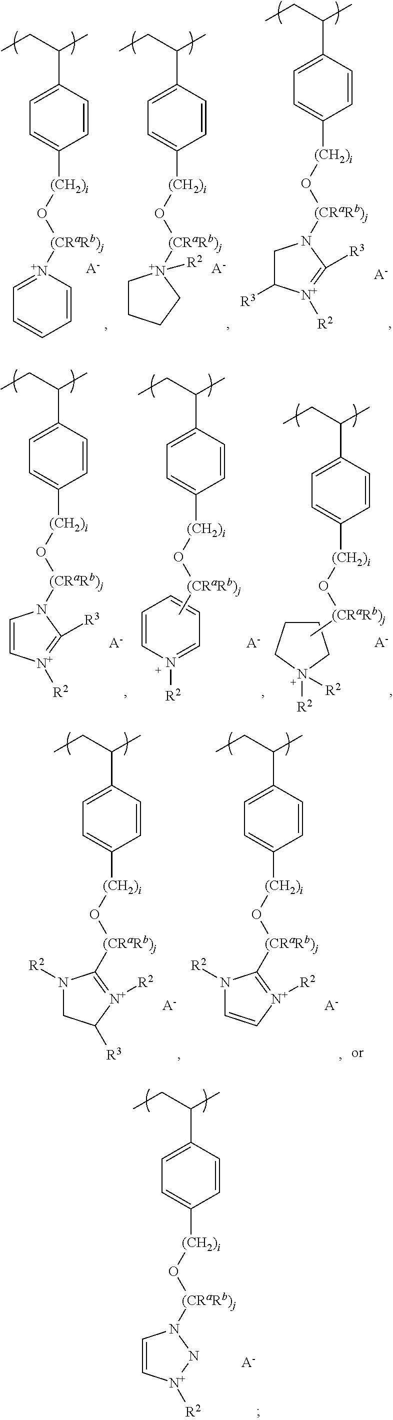
wherein A⁻ is F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; R^{a} and R^{b} are independently hydrogen, or C₁₋₈ alkyl group; i and j are independently 0, or an integer from 1 to 6; and, R² and R³ are independently hydrogen, C₁₋₈ alkyl group, vinyl group, C₆₋₁₂ aryl group, or allyl group.

6. The polymer as claimed in claim 1, wherein the first repeating unit is 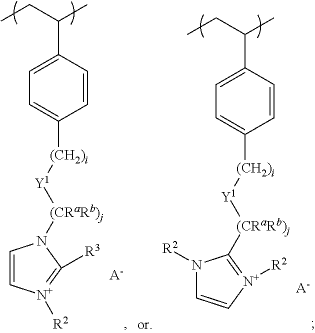
wherein A⁻ is F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; Y¹ is —O—, —S—, —CH₂—, or —NH—; R^{a} and R^{b} are independently hydrogen, or C₁₋₈ alkyl group; i and j are independently 0, or an integer from 1 to 6; and, R² and R³ are independently hydrogen, C₁₋₈ alkyl group, vinyl group, C₆₋₁₂ aryl group, or allyl group.

7. The polymer as claimed in claim 1, wherein the second repeating unit is 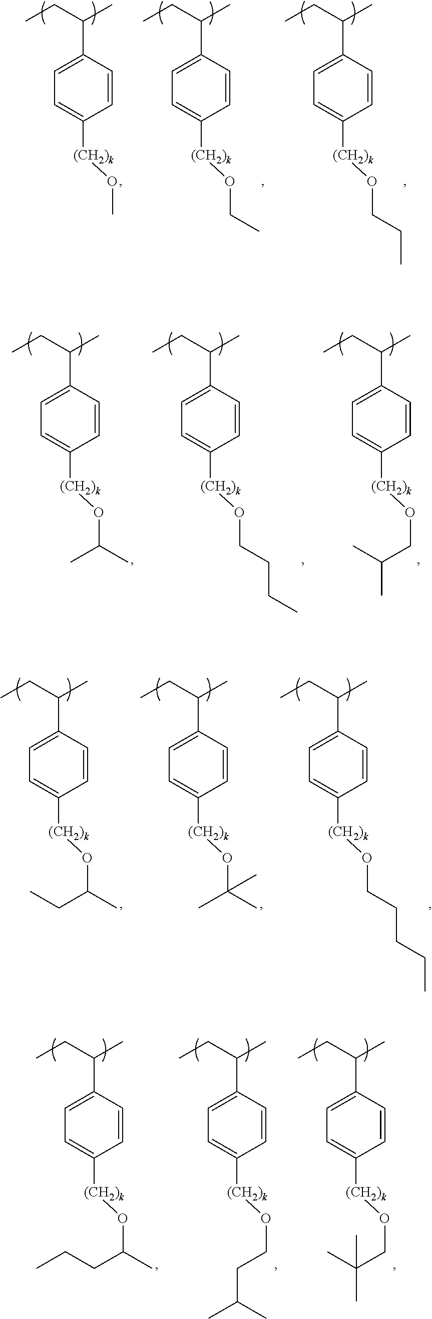 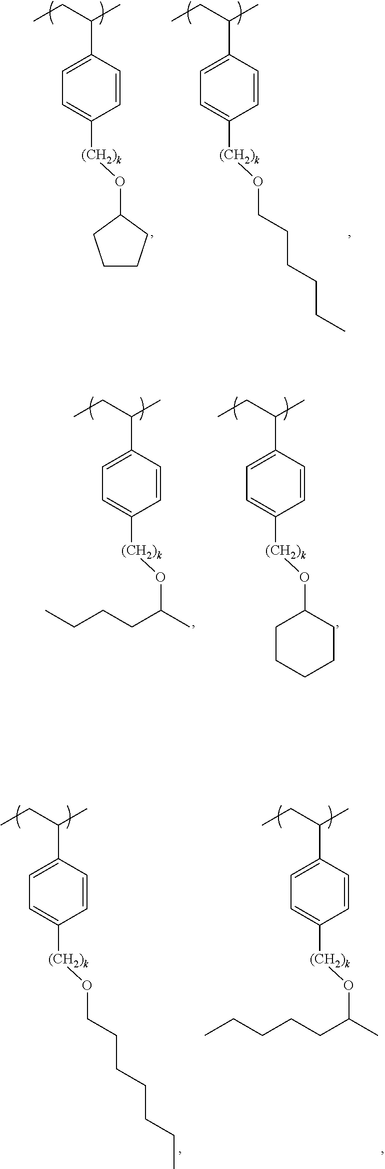 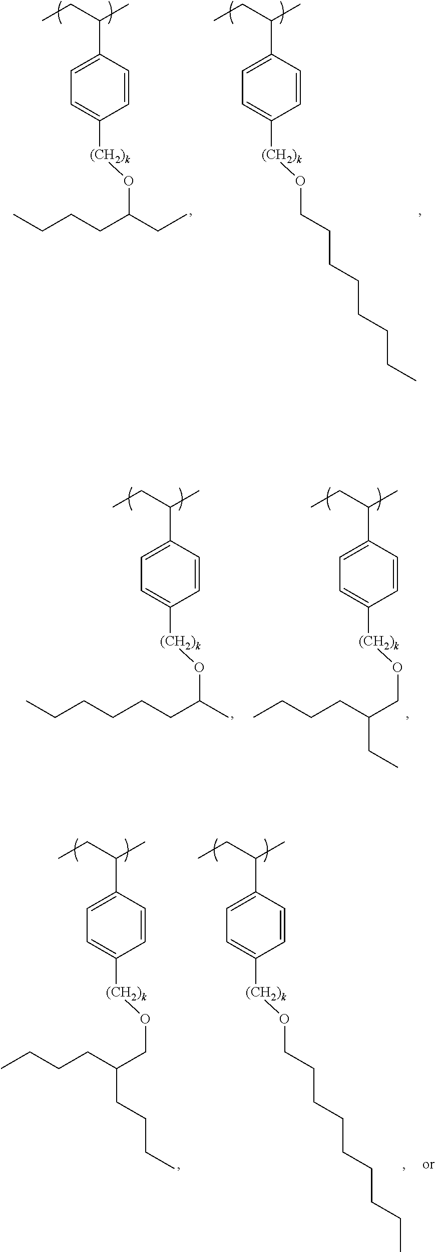 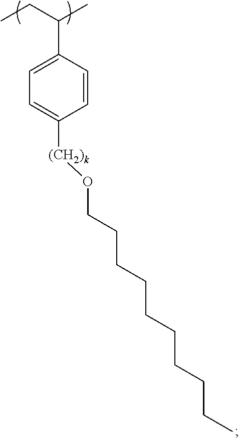
wherein k is 0, or an integer from 1 to 6.

8. An ion exchange membrane, comprising a polymer or a cross-linking polymer, wherein the polymer is the polymer as claimed in claim 1; the cross-linking polymer is a reaction product of the polymer as claimed in claim 1 and a cross-linking agent; and the cross-linking agent is a compound having at least two imide groups; and the ion exchange membrane has a thickness from 15 μm to 200 μm.

9. The ion exchange membrane as claimed in claim 8, wherein the imide group is maleimide group.

10. The ion exchange membrane as claimed in claim 8, wherein the cross-linking agent is 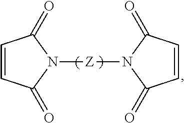
wherein Z is 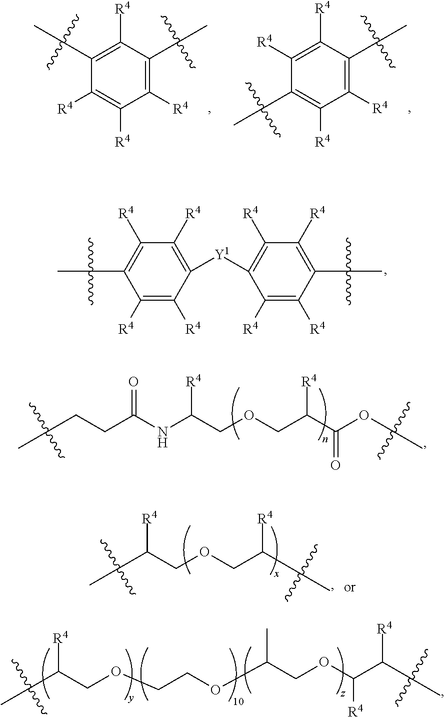
wherein Y¹ is single bond, —O—, —S—, —CH₂—, or —NH—; R₄ is independently hydrogen, or C₁₋₄ alkyl group; n≧1; x is an integer from 1 to 12; and, y and z are independently an integer from 1 to 5.

11. The ion exchange membrane as claimed in claim 8, wherein the cross-linking agent is a reaction product of a compound (a) and a compound (b), wherein the compound (a) is 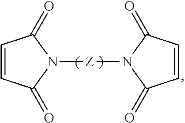
wherein Z is 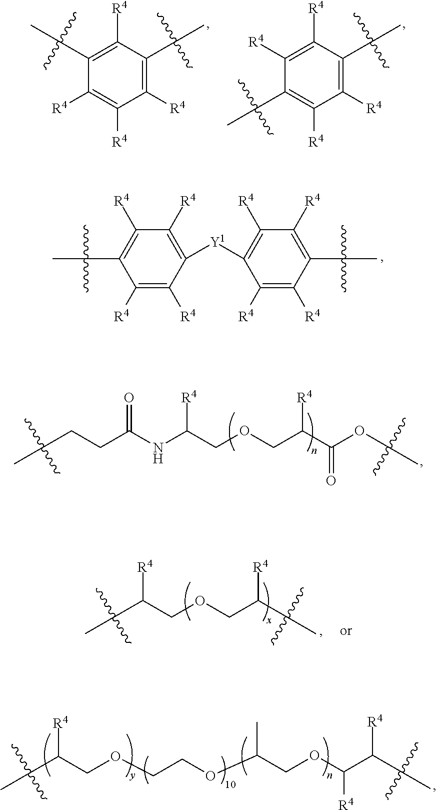
wherein Y¹ is single bond, —O—, —S—, —CH₂—, or —NH—; R⁴ is independently hydrogen, or C₁₋₄ alkyl group; and, n≧1; x is an integer from 1 to 12; and, y and z are independently an integer from 1 to 5, wherein the compound (b) has a structure represented by Formula (I) or Formula (II) 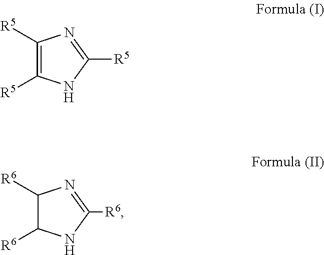
wherein R⁵ is independently hydrogen, or C₁₋₄ alkyl group; and, R⁶ is independently hydrogen, or C₁₋₄ alkyl group.

12. A structural enhanced membrane, comprising:
a polymer or a cross-linking polymer, wherein the polymer is the polymer as claimed in claim 1; the cross-linking polymer is a reaction product of the polymer as claimed in claim 1 and a cross-linking agent; and the cross-linking agent is a compound having at least two imide groups; and
a substrate, wherein the substrate has a plurality of pores.

13. The structural enhanced membrane as claimed in claim 12 wherein the polymer or the cross-linking polymer is disposed on at least one surface of the substrate and filled into the pores of the substrate.

14. The structural enhanced membrane as claimed in claim 12, wherein the substrate is polytetrafluoroethene (PTFE), polyimide (PI), polyethylene terephthalate (PET), polyether ether ketone (PEEK), polypropylene (PP), polyethylene (PE), polyvinylidene fluoride (PVDF), or a combination thereof.
